(19) United States
(12) Patent Application Publication
(10) Pub. No.: US 2026/0274414 A1
(43) Pub. Date: Sep. 17, 2026

(54) DRONE, AND CONVEYING DEVICE FOR USE IN A DRONE

(71) Applicant: LEHNER Maschinenbau GmbH, Westerstetten (DE)

(72) Inventors: Ralf HUEBNER, Westerstetten (DE); Michael STOCKER, Westerstetten (DE)

(73) Assignee: LEHNER Maschinenbau GmbH, Westerstetten (DE)

(21) Appl. No.: 19/471,886

(22) PCT Filed: Mar. 13, 2024
(86) PCT No.: PCT/EP2024/056656

§ 371 Date: Oct. 2, 2025

(30) Foreign Application Priority Data
Apr. 3, 2023 (DE) 10 2023 108 520.4

(51) Int. Cl. B64D 1/02; A01C 17/00; B33Y 80/00; B64U 101/40; B64U 101/45

(52) U.S. Cl. CPC B64D 1/02; A01C 17/001; A01C 17/008; B33Y 80/00; B64U 2101/40; B64U 2101/45

(57) ABSTRACT

A drone for spreading material to be scattered for agriculture or forestry, in particular meterable pellets to be scattered, seeds or fertilizer, includes a storage hopper which receives the material to be scattered which passes via a conveyor into a cell wheel metering device which is arranged above a spreading disk and feeds the material to be scattered to the latter in a metered manner via a conveyor funnel, with the result that material to be scattered leaves the drone in a metered manner via the rotating spreading disk.

The invention relates to a drone for spreading material to be scattered for agriculture or forestry, in particular metered pellets to be scattered, seeds or fertilizer, as well as a conveying device for use in a drone.

It is known from the general prior art to spread material to be scattered in granular form, such as seeds or fertilizer, by means of mechanical devices. Examples of such devices are known from agricultural technology and comprise, for example, centrifugal, auger or pneumatic spreaders. These are usually attached to a tractor or trailer. Recently, however, developments have also emerged that extend this approach to unmanned aerial vehicles, such as drones.

From CN 216784719 U, a seeding machine is known as an unmanned apparatus, which comprises a movable device and a seeding mechanism arranged on the movable device. The seeding mechanism comprises a frame and a spreading disk, the spreading disk includes a spreading disk body, a first blade and a second blade, and the spreading disk body is rotatably connected to the frame and is configured to rotate in a plane forming an included angle with the horizontal plane. The first blade and the second blade are arranged on the spreading disk body, and the second blade is located near the center of rotation of the spreading disk body relative to the first blade.

CN 211140907 U shows a material conveying mechanism of a fertilizer spreader, which comprises a support frame, a conveyor auger, an auger drive part, a seeding disk and a seeding disk drive part. The conveyor auger comprises a housing, an auger shaft and a spiral blade, wherein an auger feed opening and an auger outlet opening are formed in the housing. The conveying mechanism of the fertilizer spreader allows granular materials to be spread evenly, and the spreading speed of the granular materials can be controlled.

WO 2019/046837 A1 describes a seed distribution arrangement for an aerial vehicle having a distribution arrangement comprising a frame that can be selectively attached to an aircraft and at least one distribution device attached to the frame. The distribution device has a body defining a cavity for receiving a plurality of agricultural products and a drum for dispensing the plurality of products. A control device configured to communicate with the aerial vehicle and the distribution device in order to coordinate the time at which products are discharged and a distance of a subsequent discharged product relative to the speed of the aircraft.

From WO 2021/007632A1 , a system for releasing solid products for biological pest control in agriculture is known, comprising a dispensing device on board a remotely controlled manned or unmanned vehicle and a method for releasing such products in the field, either loose or in packaging such as bags or packs, depending on the specific characteristics of the product, by operating the vehicle with tasks performed by an automatic pilot or manually, and wherein the release of the product is triggered at programmed time intervals, based on programmed geographical coordinates or manually.

U.S. Pat. No. 11,083,129 B2 shows a spreading device comprising a funnel mounted axially above a generally circular hollow tube, the generally circular hollow tube forming a semi-circular funnel bottom of an interior region formed by the funnel, and a drive motor assembly mounted on the funnel and operable to rotate the generally circular hollow tube within at least a portion of the interior region formed by the funnel.

CN 217755436 U describes a feeding auger device, a spiral conveyor and a movable platform, and relates to the technical field of material conveying. The feeding auger device comprises an auger body and the auger body is provided with a spiral groove. By adjusting the size parameters on the auger body, the control accuracy of the scattering of small particles can be improved.

CN 217200946 U relates to the field of unmanned equipment, in particular to a material box and an unmanned device. The unmanned device comprises a movable platform and a material box. The material box comprises a box body, a conveyor assembly, and a first sensor, and the box body is used to store materials; the sensor is arranged in the box body and is used to detect whether materials are fed into the box body or not. The conveyor assembly is arranged in the box body and is used to convey the materials in the box body out of the box body.

CN 218 851 288 U shows a modular, removable drone seeding device comprising a feed opening, a grooved wheel, a grooved wheel motor, a spreading disk, a spreading disk motor and a housing. The grooved wheel has a rotation speed controlled by the grooved wheel motor to regulate the quantity of material to be fed, and the spreading disk is coaxially connected to the spreading disk motor. The material meets the spreading disk from the grooved wheel and the spreading disk rotates to discharge the material.

CN 112 492 944 A relates to the field of unmanned aerial vehicles, in particular a spreader for spreading seeds or granular fertilizer and an unmanned aerial vehicle with the spreader. The spreader comprises a feed unit connected to a storage hopper of the unmanned aerial vehicle and a discharge unit connected to the lower part of the feed unit. The feed unit comprises a feed housing connected to the storage hopper. A feed shaft is arranged in the feed housing for quantitatively feeding materials into the discharge unit. A feed motor for driving the feed shaft is arranged on the outer wall of the feed housing so that a plurality of feed cavities for receiving the materials are evenly distributed in the surface of the feed shaft. A sealing assembly is provided to seal the feed cavities.

DE 10 2017 005 094 A1 shows an agricultural machine for spreading material to be distributed, in particular fertilizer and/or seeds, which comprises at least one metering element with a rotatably driven metering roller mounted in a metering housing for metering the distribution material. In order to ensure precise metering of the material to be distributed within finely divided partial widths of the agricultural machine, it is provided that the metering roller of the metering element has a plurality of metering wheel segments which are driven to rotate independently of one another, wherein the metering wheel segments can either be switched on or off independently of one another or, in particular, can be driven independently of one another by means of their own drives so that they can be operated at different rotational speeds.

Based on this prior art, the inventors have now set themselves the object of creating a drone, or a conveying device for use in a drone, that allows for homogeneous dispensing of material to be scattered and a reproducible quantity for dispensing mixtures of material to be scattered, with a controllable spreading pattern.

This object is achieved by the features of claim 1 and the features of claim 10. Further advantageous embodiments of the invention are the subject matter of each of the dependent claims. These can be combined with one another in a technically meaningful manner. The description, in particular in conjunction with the drawing, additionally characterizes and specifies the invention.

In accordance with the invention, a drone is created for spreading material to be scattered for agriculture or forestry, in particular meterable pellets to be scattered, seeds or fertilizer, which comprises a storage hopper which receives the material to be scattered, which passes via a conveying means into a cell wheel metering device which is arranged above a spreading disk and feeds the material to be scattered to the latter in a metered manner via a conveyor funnel, with the result that material to be scattered leaves the drone in a metered manner via the rotating spreading disk.

In this way, it is possible to achieve a homogeneous dispensing when spreading material to be scattered by installing a cell wheel metering device between the storage hopper equipped with the conveying means, which passes on the pellets to be scattered, and the spreading disk, which feeds the pellets to be scattered to the spreading disk via the conveyor funnel. The cell wheel metering device decouples the rotating spreading disk from the storage hopper, as the pellets to be scattered are no longer subjected to suction forces caused by the rotating spreading disk, which could influence the dispensing of the pellets to be scattered. Furthermore, the dispensing of the pellets to be scattered can be adjusted very precisely via the cell wheel metering device, which also leads to improved homogeneity of the dispensing of the material to be scattered compared to known drones with spreading apparatuses.

In accordance with one embodiment of the invention, the cell wheel metering device is segmented into a plurality of cell wheels along a cell wheel axis.

Segmenting the cell wheel metering device along the rotary axis is advantageous in particular in order to be able to adjust the dispensing of the pellets to be scattered along the cell wheel axis, so that in this way both the quantity and the selection of the point(s) of impact of the pellets to be scattered on the spreading disk can be determined for the particular application.

In accordance with a further embodiment of the invention, the cell wheels are interchangeable for changing the dispensing of the material to be scattered or for changing the spreading pattern and the cell wheels are replaceable by cell wheels of different shapes and sizes or by non-functional placeholders. The cell wheels can span the spreading disk on both sides of the axis of rotation, at least in portions.

In addition to the use of different pre-assembled cell wheels for different applications, it is also intended in particular to make the cell wheels interchangeable in order to change the spreading pattern on the cell wheel axis. Cell wheels of different shapes and sizes can be used, but non-functional placeholders can also be arranged instead of individual cell wheels. In this way, the quantity and position of the point of impact of the pellets to be scattered on the spreading disk can be further optimized for the particular application. If, for example, it is desired to dispense the pellets to be scattered only on one side of the drone's flight path, non-functional placeholders can be fitted on the side opposite the axis of rotation of the spreading disk instead of cell wheels. This means that the equipping of the cell wheel metering device makes it possible to select from three different variants, allowing the material to be dispensed at one side or at both sides. The size of the cell wheels is selected according to the size of the pellets to be scattered, which is particularly advantageous when changing from pellets to be scattered of one grain size to mixtures with different grain sizes.

In accordance with a further embodiment of the invention, the cell wheel axis is arranged perpendicularly or in an angular range of ±30° to an axis of rotation of the spreading disk.

In order to minimize the influence of the downward-flowing air generated by the rotors during flight operation of the drone, it can be necessary to optimize the angle of the cell wheel axis to the axis of rotation of the spreading disk. This also includes tilting at an angular range of +30° to the axis of rotation of the spreading disk. However, the choice of the angular range depends on the specific design of the drone's rotors, and can be determined experimentally, for example.

In accordance with a further embodiment of the invention, the cell wheel metering device can be removed via a cover that can be attached to a housing wall, wherein the cover is fastened to the housing wall with a quick-release fastener.

In this way, the configuration of the cell wheel metering device can be changed quickly, allowing the rotary feeders to be replaced.

In accordance with a further embodiment of the invention, the spreading disk can be detached from the axis of rotation without tools, preferably via a bayonet lock.

The tool-free detachment of the spreading disk from the axis of rotation allows for easy maintenance of the drone or quick replacement of the spreading arms arranged on it.

In accordance with a further embodiment of the invention, the conveyor funnel is designed in its interior with inclined surfaces which are dimensioned with respect to their inclination to an axis of rotation of the spreading disk so that material to be scattered of different sizes can pass through the conveyor funnel.

In this way, it is possible to spread different materials to be scattered with the drone according to the invention, which is particularly advantageous when using seed mixtures, since the individual components can have different sizes. Coated seeds can also be dispensed in this way.

In accordance with a further embodiment of the invention, the conveyor funnel opens from an inlet portion below the conveying means into two tubular funnel portions which are arranged on either side of the axis of rotation of the spreading disk.

Due to this procedure, the drone according to the invention is designed with two points of impact on the spreading disk, which are arranged on both sides of the axis of rotation of the spreading disk. This makes it possible to dispense the pellets to be scattered over a large spatial region.

In accordance with a further embodiment of the invention, at least the spreading disk, the conveyor funnel and the cell wheels are made of plastics material, preferably using a 3D printing process.

In this way, cost-effective production of the drone according to the invention is possible without having to use injection molds. This also allows for quick adaptation to individual customer requirements.

Furthermore, a cell wheel metering device for use in a drone is specified, which is segmented into a plurality of cell wheels along a cell wheel axis, wherein the cell wheels are interchangeable to change the dispensing of the material to be scattered or to change the spreading pattern and can be replaced by cell wheels of different shapes and sizes or by non-functional placeholders.

Some exemplary embodiments are explained in greater detail below with reference to the drawings. In the drawings:

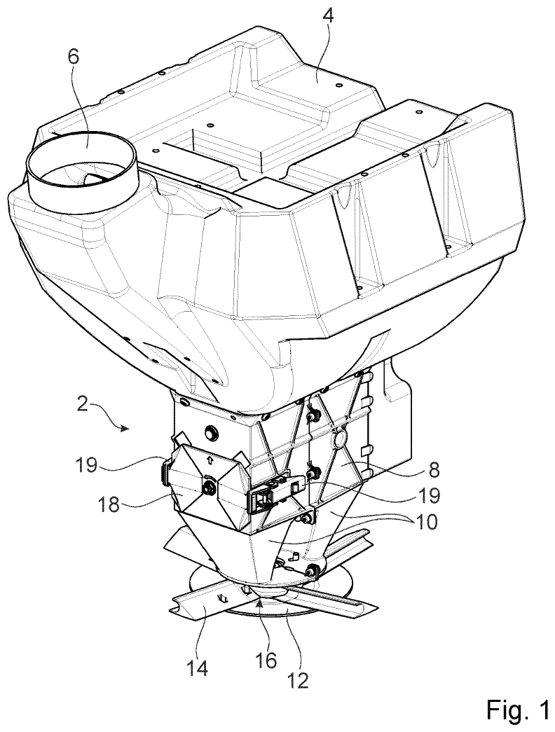

FIG. 1 shows part of a device according to the invention in a perspective side view,

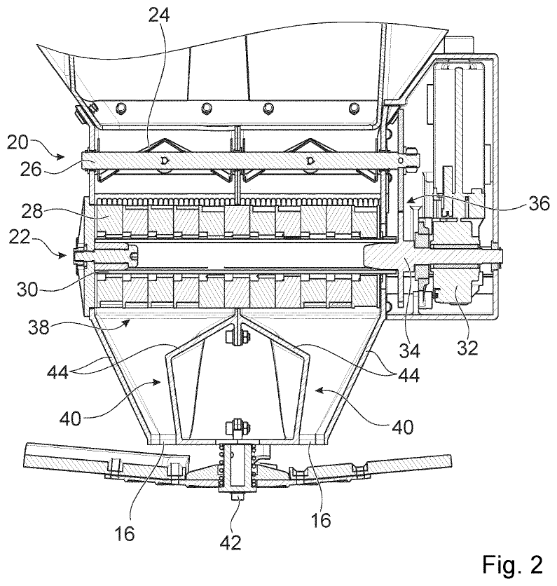

FIG. 2 shows a detail from FIG. 1 in a sectional view,

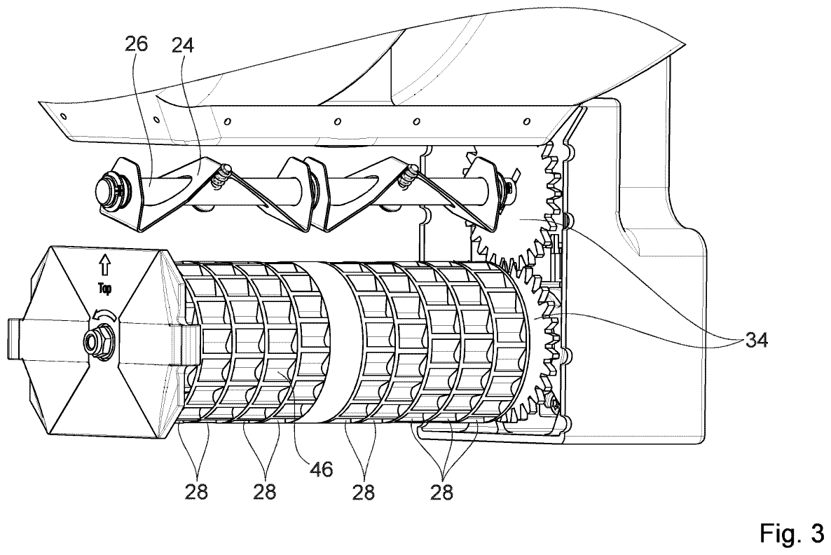

FIG. 3 shows a further detail from FIG. 1 in a perspective side view,

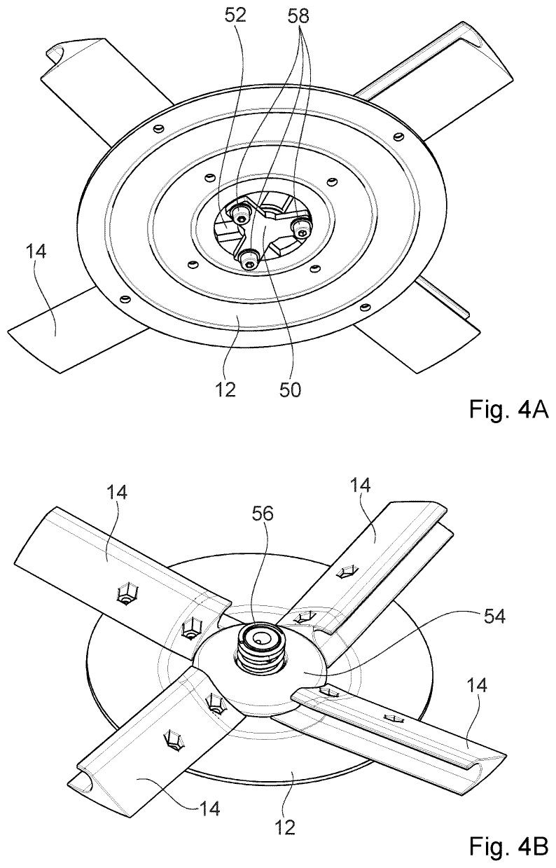

FIG. 4A shows a further detail of FIG. 1 in a perspective side view, and

FIG. 4B shows a further detail of FIG. 1 in a perspective side view.

In the drawings, the same or functionally equivalent components are provided with the same reference signs.

With reference to FIG. 1, an embodiment of a conveying device 2 for use in a drone is described. The drone can be used to spread material to be scattered for agriculture or forestry, in particular metered pellets to be scattered such as seeds or fertilizer. The conveying device 2 as a component of the drone is only described with regard to its components that are important for the dispensing of the pellets to be scattered. Other aspects of the drone, relating for example to its ability to fly, are not the subject matter of the invention. However, these aspects can easily be added in supplemental fashion within the scope of normal practice of a person skilled in the art.

The conveying device 2 comprises on its upper side a storage hopper 4 which can be filled with the material to be scattered via a filling opening 6. Below the storage hopper 4, within a housing 8, the actual metering mechanism is arranged, via which the material to be scattered is conveyed to a conveyor funnel 10 and from there to a spreading disk 12. The metering mechanism is described in more detail below.

On the spreading disk 12, a plurality of spreading arms 14 are provided, which guide the material to be scattered radially outwards when the spreading disk 12 rotates, so that the material to be scattered can leave the conveying device 2. The spreading pattern of the conveying device 2 can be influenced by the point of impact of the material to be scattered on the spreading disk 12, the rotational speed of the spreading disk 12, and the dispensed quantity of the material to be scattered. The material to be scattered leaves the conveyor funnel 10 in the direction of the spreading disk 12 via openings 16 which are arranged on the underside of the conveyor funnel 10.

The dispensing amount of the material to be scattered is controlled by the metering mechanism located behind the housing 8, having a cover 18. The cover 18 is attached to the housing 8 by quick-release fasteners 19 to allow quick access to the interior of the housing 8.

With reference to FIG. 2, the metering mechanism is explained in more detail in a sectional view. The sectional plane runs approximately through the center of the spreading disk 12. It can be seen that in the interior of the housing 8 there is a conveying means 20 which, similar to an agitator, transports material to be scattered from the storage hopper 4 to a cell wheel metering device 22 as a metering mechanism. The conveying means 20 comprises conveyor arms 24 which are arranged around a shaft 26. The cell wheel metering device 22 is segmented into a plurality of cell wheels 28 which are arranged along a hollow shaft 30. The drive of the cell wheel metering device 22 and of the conveying means 20 is effected by an electric motor 32, which is connected to the shaft 26 and the hollow shaft 30 via a projection 34 and a pair of gears 36.

On the underside of the cell wheel metering device 22 the conveyor funnel 10 is connected, which opens from an inlet portion 38 below the cell wheel metering device 22 into two tubular funnel portions 40 which are arranged on either side of an axis of rotation 42 of the spreading disk 12. The conveyor funnel 10 is designed in its interior with inclined surfaces 44 which are dimensioned with respect to their inclination to the axis of rotation 42 of the spreading disk 12 such that material to be scattered of different sizes can pass through the conveyor funnel 10 at the openings 16.

The orientation of the hollow shaft 30 here corresponds to a cell wheel axis around which the rotation of the cell wheels 28 takes place. The cell wheel axis can be arranged perpendicularly or in an angular range of ±30° to the axis of rotation 42 of the spreading disk 12. The cell wheels 28 can be interchangeable in order to adapt to the grain size of the material to be scattered. Cell wheels can be replaced by cell wheels of different shapes and sizes or by non-functional placeholders. The cell wheels 28 span the spreading disk 12 on both sides of the axis of rotation 42 at least in individual portions.

With reference to FIG. 3, the structure of the conveying means 20 and of the cell wheel metering device 22 is shown again in a perspective side view, in which in particular the housing 8 has been removed. It can be seen that the cell wheel metering device 22 has individual conveyor cells 46 on the cell wheels 28, which cells transport the material to be scattered in a rotating movement. The size and number of conveyor cells 46 can be adapted to the particular application by exchanging cell wheels 28 of the cell wheel metering device 22.

FIGS. 4A and 4B show another detail of the spreading disk 12. The spreading disk 12 can be removed from its axis of rotation 42 without tools, for which purpose a bayonet lock is provided. For this purpose, as shown in FIG. 4A, a star-shaped extension 50 is provided at the end of the axis of rotation 42, which can penetrate corresponding openings 52 on the spreading disk 12 and comes to lie between the openings 52. On the back of the spreading disk 12, as shown in FIG. 4B, a counterpiece 54 is arranged, which is pressed by a spring 56 in the direction of the end of the axis of rotation. The locking augers 58 shown serve only as additional securing means during the testing phase and can be omitted later.

The features indicated above and in the claims, as well as the features which can be seen in the figures, can advantageously be implemented both individually and in various combinations. The invention is not limited to the described exemplary embodiments, but can be modified in many ways within the scope of the capabilities of a person skilled in the art.

### LIST OF REFERENCE SIGNS

2 Conveying device
4 Storage hopper
6 Filling opening
8 Housing
10 Conveyor funnel
12 Spreading disk
14 Spreading arms
16 Openings
18 Cover
19 Quick-release fasteners
20 Conveying means
22 Cell wheel metering device
24 Conveyor arms
26 Shaft
28 Cell wheels
30 Hollow shaft
32 Electric motor
34 Projection
36 Pair of gears
38 Inlet portion
40 Funnel portions
42 Rotation shaft
44 Inclined surfaces
46 Conveyor cells
50 Extension
52 Openings
54 Counterpiece
56 Spring

1: A drone for spreading material to be scattered for agriculture or forestry, in particular meterable pellets to be scattered, seeds or fertilizer, which comprises a storage hopper (4) which receives the material to be scattered which passes via a conveying means (20) into a cell wheel metering device (22) which is arranged above a spreading disk (12) and feeds the material to be scattered to the latter in a metered manner via a conveyor funnel (10), with the result that material to be scattered leaves the drone in a metered manner via the rotating spreading disk (12).

2: The drone according to claim 1, wherein the cell wheel metering device (12) is segmented into a plurality of cell wheels (28) along a cell wheel axis.

3: The drone according to claim 2, in which the cell wheels (28) are interchangeable for changing the delivery of the material to be scattered or for changing the spreading pattern and in which the cell wheels (28) are replaceable by cell wheels (28) of different shapes and sizes or by non-functional placeholders.

4: The drone according to claim 2, in which the cell wheel axis is arranged perpendicularly or in an angular range of ±30° to an axis of rotation (42) of the spreading disk (12) and the cell wheels (28) can span the spreading disk (12) on both sides of the axis of rotation (42) at least in portions.

5: The drone according to claim 1, wherein the cell wheel metering device (22) can be removed via a cover (18) attachable to a housing wall (8), wherein the cover (19) is fastened to the housing wall (8) with a quick-release fastener (19).

6: The drone according to claim 1, wherein the spreading disk (12) can be detached from the axis of rotation (42) without tools, preferably via a bayonet lock.

7: The drone according to claim 1, in which the conveyor funnel (10) is designed in an interior of the conveyor funnel (10) with inclined surfaces which are dimensioned with respect to their inclination to an axis of rotation (42) of the spreading disk (12) such that material to be scattered of different sizes can pass through the conveyor funnel (10).

8: The drone according to claim 1, in which the conveyor funnel (10) opens from an inlet portion (38) below the cell wheel metering device (22) into two tubular funnel portions (40) which are arranged on either side of the axis of rotation (42) of the spreading disk (12).

9: The drone according to claim 1, in which at least the spreading disk (12), the conveyor funnel (10) and the cell wheels (28) are made of plastics material, preferably in a 3D printing process.

10: A cell wheel metering device for use in a drone, which is segmented into a plurality of cell wheels (28) along a cell wheel axis, wherein the cell wheels (28) are interchangeable to change the dispensing of the material to be scattered or to change the spreading pattern and can be replaced by cell wheels (28) of different shapes and sizes or by non-functional placeholders.
